(19) United States
(12) Patent Application Publication
(10) Pub. No.: US 2022/0326373 A1
(43) Pub. Date: Oct. 13, 2022

(54) AERIAL ANALYSIS OF GROUND SURFACE USING DISTANCE SENSOR OF UNMANNED AERIAL VEHICLE

(71) Applicant: INDUSTRY ACADEMY COOPERATION FOUNDATION OF SEJONG UNIVERSITY, Seoul (KR)

(72) Inventors: Jin Woo Song, Seoul (KR); Yeong Seo Kwon, Seoul (KR); Yong Hun Kim, Seoul (KR); Do Hoang Viet, Seoul (KR)

(73) Assignee: INDUSTRY ACADEMY COOPERATION FOUNDATION OF SEJONG UNIVERSITY, Seoul (KR)

(21) Appl. No.: 17/535,737

(22) Filed: Nov. 26, 2021

(30) Foreign Application Priority Data
Apr. 13, 2021 (KR) 10-2021-0047843

(51) Int. Cl. G01S 13/89; G01S 13/935

(52) U.S. Cl. CPC G01S 13/89; G01S 13/935

(57) ABSTRACT

There is provided a method for aerial analysis of a ground surface. The disclosed method includes: controlling a distance sensor of an unmanned aerial vehicle (UAV) to be successively oriented in a plurality of sensing directions towards the ground surface; and analyzing the ground surface based on distance measurement data indicative of distances measured by the distance sensor in the plurality of sensing directions, the plurality of sensing directions corresponding to respective points defining a planar trajectory, the planar trajectory including a plurality of loops winding an identical inner point.

### FIELD

The present disclosure relates to aerial analysis of a ground surface using a distance sensor of an unmanned aerial vehicle (UAV).

### BACKGROUND

There has been a lot of research activity to utilize unmanned vehicles, and in particular unmanned aerial vehicles (UAVs) such as drones, in various environments. In a certain environment, it may be necessary for a UAV to aerially investigate information regarding a ground surface. For example, if during its flight, the UAV has lost a control signal therefor, developed its engine problem, or run out of its power, the UAV may attempt an emergency landing in an unknown environment, where there does not exist a previously designated landing zone, which attempt may be preceded by selecting a safe landing zone based on the ground surface information. Several studies have been directed towards employing an image sensor such as a camera attached to an aerial vehicle to aerially capture an image of a ground surface and classifying the captured image with Artificial Intelligence (AI) or Machine Learning (ML). It has also been proposed to use a distance sensor with a wide field of view (FoV) of, e.g., 360 degrees, for downward inspection of a ground surface.

### SUMMARY

Disclosed herein is aerial analysis of a ground surface using a distance sensor of a UAV.

In an example, a method for aerial analysis of a ground surface includes: controlling a distance sensor of an unmanned aerial vehicle (UAV) to be successively oriented in a plurality of sensing directions towards the ground surface; and analyzing the ground surface based on distance measurement data indicative of distances measured by the distance sensor in the plurality of sensing directions, the plurality of sensing directions corresponding to their respective points defining a planar trajectory, the planar trajectory including a plurality of loops winding an identical inner point.

This Summary is provided to introduce a few aspects in a simplified form that are further described below in the Detailed Description. This Summary is not intended to identify key features or essential features of the claimed subject matter, nor is it intended to be used to determine the scope of the claimed subject matter. Furthermore, the claimed subject matter is not limited to implementations that offer any or all advantages discussed herein.

In accordance with the present disclosure, it is possible to aerially analyze a ground surface using a distance sensor included in a UAV.

In accordance with the present disclosure, it is possible to figure out an undulation of a ground surface based on distance measurement data provided from a distance sensor of a UAV.

In accordance with the present disclosure, when attempting an emergency landing in an unknown environment, a UAV may determine a safe landing zone in a rapid and accurate manner while refraining from or minimizing movement of the UAV.

### BRIEF DESCRIPTION OF THE DRAWINGS

FIG. 1 is a block diagram illustrating an example of a navigation and control system of an example unmanned aerial vehicle (UAV).

FIG. 2 illustrates an example field of view (FoV) of a distance sensor of the UAV of FIG. 1.

FIG. 3 is a diagram for demonstrating example successive orientations of the distance sensor of the UAV of FIG. 1.

FIG. 4 illustrates various examples of the planar trajectory of FIG. 3.

FIG. 5 illustrates an example FoV projection of the distance sensor of the UAV of FIG. 1.

FIG. 6 illustrates another example FoV projection of the distance sensor of the UAV of FIG. 1.

FIG. 7 is a flow diagram illustrating an example of a process of selecting a landing zone for the UAV of FIG. 1.

FIGS. 8A to 8C illustrate examples of three respective types of maps that may be constructed in ground surface analysis using the distance sensor of the UAV of FIG. 1.

FIG. 9 illustrates a result of a computer simulation for performance testing of the process of FIG. 7.

### DETAILED DESCRIPTION

Various terms used in the present disclosure are chosen from a terminology of commonly used terms in consideration of their function herein, which may be appreciated differently depending on an intention of a person skilled in the art, a precedent case, or an emerging new technology. In specific instances, some terms are ascribed their meanings as set forth in the detailed description. Accordingly, the terms used herein are to be defined consistently with their meanings in the context of the present disclosure, rather than simply by their names.

The terms “comprising,” “including,” “having,” etc. are used herein when specifying the presence of the elements listed thereafter, e.g., certain features, numbers, steps, operations, constituent elements, information, or a combination thereof. Unless otherwise indicated, these terms and variations thereof are not meant to exclude the presence or addition of other elements.

As used herein, the terms “first,” “second,” and so forth are meant to identify several similar elements. Unless otherwise specified, such terms are not intended to impose limitations, e.g., a particular order of these elements or of their use, but rather are used merely for referring to multiple elements separately. For instance, an element may be referred to in an example with the term “first” while the same element may be referred to in another example with a different ordinal number such as “second” or “third.” In such examples, these terms are not to limit the scope of the present disclosure. Also, the use of the term “and/or” in a list of multiple elements is inclusive of all possible combinations of the listed items, including any one or plurality of the items. Further, singular expressions include plural expressions unless expressly stated otherwise.

Certain examples of the present disclosure will now be described in detail with reference to the accompanying drawings. The present disclosure may, however, be embodied in many different forms and should not be construed as limited to the examples set forth herein; rather, these examples are given in order to provide a better understanding of the scope of the present disclosure.

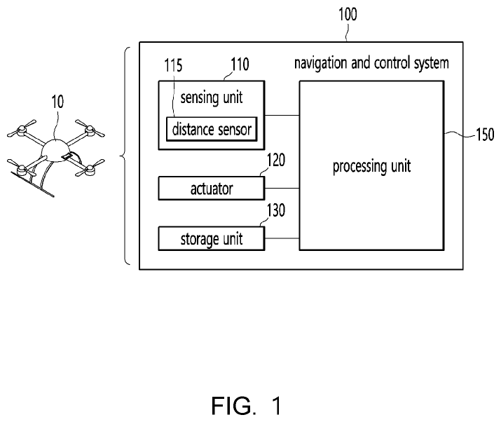

FIG. 1 is a block diagram illustrating an example of a navigation and control system 100 of an example unmanned aerial vehicle (UAV) 10. Examples of the UAV 10 include a rotorcraft drone having one or more rotors or rotor blades, such as a quadcopter drone with four rotors, as well as other types of UAVs. In a particular example, the UAV 10 may be an aerial vehicle capable of vertical take-off and landing (VTOL).

The example navigation and control system 100 of FIG. 1 provides a control input that causes the UAV 10 to operate in a controlled manner, for example, to fly along a controlled path, to move at a controlled velocity, to maintain a controlled attitude, and so forth, and computes current navigation information, which is indicative of, e.g., a location, a velocity, and an attitude of the UAV 10, based upon measurement information from an inertial sensor mounted on the UAV 10 and upon previous navigation information. In some examples, the navigation and control system 100 may have mechanisms to receive auxiliary information from an external navigation system, e.g., Global Navigation Satellite Systems such as Global Positioning System (GPS), and to use the auxiliary information to mitigate or eliminate errors in the inertial navigation.

In the example of FIG. 1, the navigation and control system 100 includes a sensing unit 110, an actuator 120, a storage unit 130, and a processing unit 150. Other example implementations of the navigation and control system 100 are also contemplated. For example, the navigation and control system 100 may also include an additional component that is not shown and/or may include some of, but not all of, the components shown in FIG. 1.

In the illustrated example, the sensing unit 110 includes a distance sensor 115. The distance sensor 115 measures a distance from the distance sensor 115 to a target object in a given sensing direction. For example, the distance sensor 115 may include a non-image sensor, such as a radar sensor, an ultrasonic sensor, a light detection and ranging (LiDAR) sensor, or the like, which may provide measurement data less susceptible to an environmental factor, e.g., smoke and fog, as compared to an image sensor.

Accordingly, the processing unit 150 may acquire, from the distance sensor 115, distance measurement data indicative of the distance measured in the sensing direction. The term “sensing direction” is intended to mean a main direction for measurement by an employed sensor, e.g., a direction of radiation of a detection signal from the distance sensor 115, a direction of reflection of the detection signal on a target object, or a combination thereof. For example, a heading direction of the distance sensor 115 may point from a rear end of the distance sensor 115 to a front end of the distance sensor 115, e.g., on which there are located a transmitter to radiate the detection signal and a receiver to receive the reflected signal, and may be given as a sensing direction.

In some example implementations, the distance sensor 115 may be mounted on the UAV 10 to have limited attitude angles, e.g., a combination of a yaw angle and a pitch angle. For example, the front end of the distance sensor 115 is capable of a circular motion with the rear end thereof fastened to a bottom surface of the UAV 10, and thus the heading direction of the distance sensor 115 may be in a downward direction, either vertically downward or slantingly downward, to a limited extent. In this example, an orientation of the distance sensor 115 may be allowed within a limited direction range.

In the example of FIG. 1, under control of the processing unit 150, the actuator 120 may orient the distance sensor 115 towards a certain direction. For example, the actuator 120 may include an electric motor actuator, a rotary actuator, and/or another type of actuator for use in adjusting an attitude angle of the distance sensor 115.

In some example implementations, the distance sensor 115 may be oriented in a certain direction by the actuator 120 in accordance with a control input provided from the processing unit 150 to the actuator 120. Such orientation of the distance sensor 115 may be for the distance sensor 115 to perform distance measurement at least in that direction. Then, the distance sensor 115 may be referred to as being oriented in a given sensing direction. In this way, the distance sensor 115 may be controlled to be successively oriented in several sensing directions, for example, such that its heading direction follows a certain trajectory over a time period.

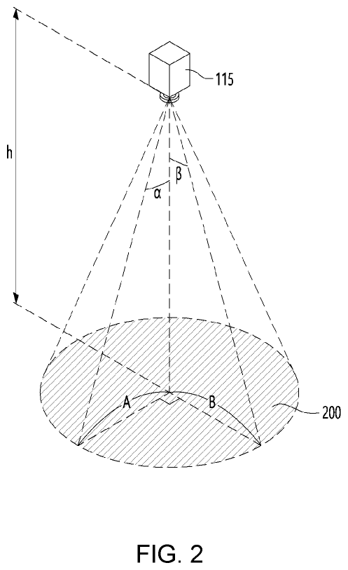

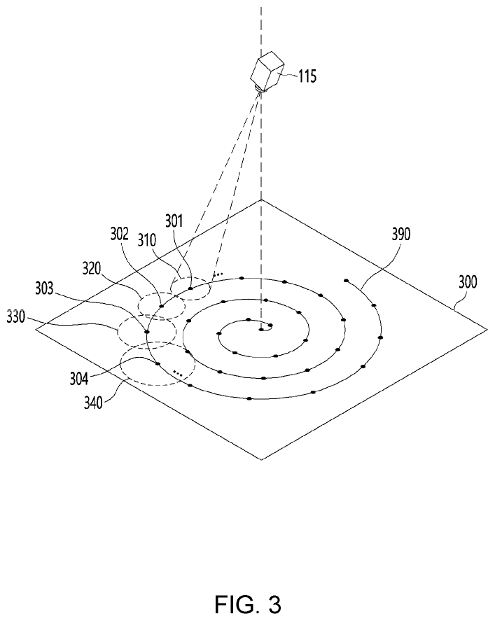

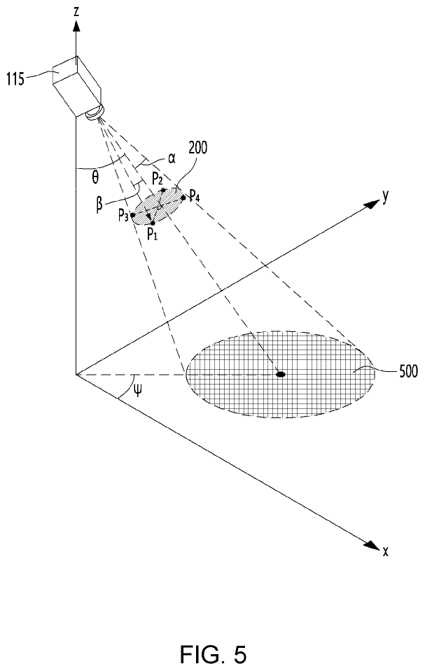

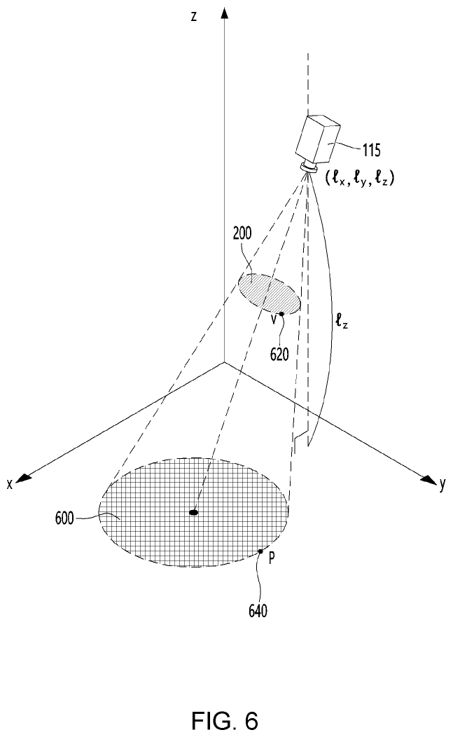

The distance sensor 115 may detect, and measure a distance to, a target object only when the target object is present in a Field of View (FoV) of the distance sensor 115, which means a whole span within which certain target objects can be observed. As shown in FIG. 2, the FoV of the distance sensor 115 is defined by a limited vertical angle of view α and a limited horizontal angle of view β. Thus, it can be said that the FoV of the distance sensor 115 represents a region 200 having a boundary determined by such angles, for example, having an elliptical shape whose semi minor and major axes are respectively A=h tan α and B=h tan β, or vice versa, on a plane which is perpendicular to the heading direction of the distance sensor 115 at any given distance h, and, put another way, that the FoV of the distance sensor 115 also represents a perspective projection of the region 200 from the distance sensor 115 onto another plane. In this regard, the region 200, as well as the region into which the region 200 is perspectively projected, may be referred to as a region into which the FoV is projected on a certain plane. Therefore, the FoV of the distance sensor 115 may be described as, for example, the projection region 200. It is seen therefrom that a sensing direction given to the distance sensor 115 points to a certain point within the FoV of the distance sensor 115, that is, within the region 200 into which the FoV is projected. In the example of FIG. 2, the point may be a center point of the projection region 200, at which the heading direction of the distance sensor 115 intersects the region 200. It is to be understood that although FIG. 2 illustrates the region 200 into which the FoV of the distance sensor 115 is projected on the plane perpendicular to the heading direction of the distance sensor 115, the FoV of the distance sensor 115 may also be represented as a region into which it is projected onto a plane that is not perpendicular to the heading direction of the distance sensor 115, for example, the regions 310, 320, 330, and 340 shown in FIG. 3, the region 500 shown in FIG. 5, and the region 600 shown in FIG. 6.

In some example implementations, the sensing unit 110 may further include an additional sensor to provide other measurement data. For example, such sensor may be an inertial sensor, e.g., a gyroscope, and thus the processing unit 150 may calculate a location, a velocity and/or an attitude of the UAV 10 using measurement data, e.g., angular velocity measurement data, that is output from this sensor.

In the example of FIG. 1, the storage unit 130 stores a variety of information. For example, the storage unit 130 may include a computer readable storage medium that stores data in a non-transitory form. Thus, the storage unit 130 may have stored therein varied information, for example, a set of instructions that are to be executed by the processing unit 150, and/or other information.

In some example implementations, the storage unit 130 may store a map that is constructed through a ground surface analysis process as described below, such as a topographic map, a slope rate map, and a roughness map, which may be defined for a plurality of points in a given target environment, e.g., a plurality of coordinate points of a ground surface of an unknown environment. For example, the topographic map may be constructed to represent an undulation of a ground surface of the target environment, the slope rate map may be constructed to represent a local change rate feature of the undulation, and the roughness map may represent another local change rate feature of the undulation, all of which maps will be described in detail below.

In the example of FIG. 1, the processing unit 150 controls the overall operations of the navigation and control system 100. For example, the processing unit 150 may be implemented with a processor or other processing circuitry to perform an operation described herein.

In some example implementations, the processing unit 150 may perform operations for aerial analysis of a ground surface, which operations may involve controlling the distance sensor 115 of the UAV 10 to be successively oriented in several sensing directions and analyzing the ground surface based on distance measurement data indicative of distances respectively measured in the sensing directions.

An example process for such ground surface analysis is now described with reference to FIGS. 3 to 6. By way of example, this process may be performed during hovering of the UAV 10 above the ground surface.

First, the processing unit 150 may control the distance sensor 115 of the UAV 10 to be successively oriented in a plurality of sensing directions towards the ground surface, where these sensing directions correspond to their respective points defining a planar trajectory. For example, as shown in FIG. 3, the plurality of sensing directions in which the distance sensor 115 is successively oriented may respectively point to their corresponding points, e.g., points 301, 302, 303, and 304, defining a planar trajectory 390 on a plane 300. In this example, these sensing directions include one or more slantingly downward directions and may further include one vertically downward direction.

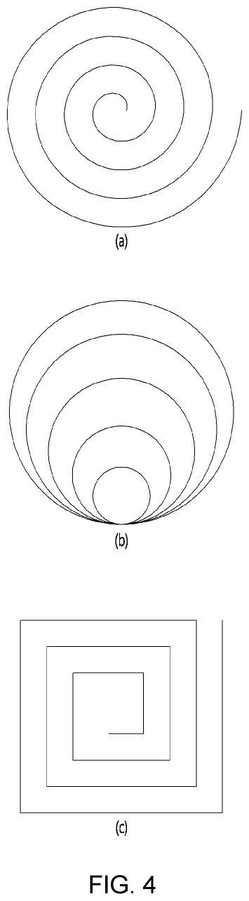

In some example implementations, the planar trajectory 390 on the plane 300 may include a plurality of loops winding an identical inner point, e.g., a point at which the vertically downward direction intersects the plane 300. Therefore, each of the plurality of loops may wind an inner one of the plurality of loops, or may be wound by an outer one of the plurality of loops, or both. Further, each loop may be an open-ended loop, e.g., a C-shaped loop, or may be a closed loop, e.g., an O-shaped loop. In a particular example, the planar trajectory 390 may be a spiral trajectory as shown in FIG. 3. The term “spiral trajectory” is intended to encompass a circular spiral trajectory, an angled spiral trajectory, and a combination thereof. FIG. 4 illustrates various examples of the planar trajectory 390. In FIG. 4, (a) to (c) are illustrative of a circular spiral trajectory, a multi-closed-loop trajectory, and an angled spiral trajectory, respectively.

With the distance sensor 115 having a limited FoV as shown in FIG. 2, successively orienting the distance sensor 115 in such manner as described above allows the distance measurement and analysis to be effectively performed for as wide a portion of a ground surface as possible, e.g., as permitted by its capability such as a maximum measurable distance to the ground surface, while considerably restraining movement of the UAV 10, rather than having the UAV 10 itself fly in zigzags or revolve in a helical manner. For example, such successive orientations of the distance sensor 115 may be helpful in analyzing the ground surface while maintaining cautious movement, e.g., hovering, of the UAV 10 so as to land the UAV 10 in a safe manner without its collision with an unrecognized obstacle in an unknown environment full of uncertainty.

In some example implementations, in order for the distance sensor 115 to be successively oriented in the plurality of sensing directions, the processing unit 150 may determine a subsequent sensing direction based on a region into which, in a current sensing direction, the FoV of the distance sensor 115 is projected on a reference plane, e.g., the plane 300.

For example, the plurality of sensing directions in which the distance sensor 115 is successively oriented may be determined such that a region into which, in a subsequent one of these sensing directions, the FoV of the distance sensor 115 is projected on the reference plane has a larger area than that of a region into which, in a current one of these sensing directions, the FoV of the distance sensor 115 is projected on the reference plane. In the example of FIG. 3, by, e.g., gradually increasing the yaw and the pitch angles of the distance sensor 115 such that the heading direction of the distance sensor 115 follows the planar trajectory 390 from its inner portion to its outer portion, the processing unit 150 may cause the distance sensor 115 to be successively oriented, starting with, e.g., the vertical downward direction, in an order of slantingly downward directions having their corresponding points on the planar trajectory 390 that are increasingly farther from the distance sensor 115, e.g., in an order of directions pointing to the point 301, followed by the point 302, followed by the point 303, followed by the point 304. This means that the region 320 has a larger area that that of the region 310, the region 330 has a larger area than that of the region 320, and the region 340 has a larger area than that of the region 330.

Additionally or alternatively, the plurality of sensing directions in which the distance sensor 115 is successively oriented may be determined such that the region into which, in the current one of these sensing directions, the FoV of the distance sensor 115 is projected on the reference plane partially overlaps the region into which, in the subsequent one of the these sensing directions, the FoV of the distance sensor 115 is projected on the reference plane, e.g., such that the overlapping part accounts for not less than a lower limit percentage and not greater than an upper limit percentage of each of the projection regions. As shown in FIG. 3, the region 310 into which, in the current sensing direction pointing to the point 301, the FoV of the distance sensor 115 is projected on the plane 300 overlaps the region 320 into which, in the subsequent sensing direction pointing to the point 302, the FoV of the distance sensor 115 is projected on the plane. Likewise, the region 320 overlaps the region 330, the region 330 overlaps the region 340, and so forth. In various examples, the partial overlapping of two projection regions on the plane 300 with each other is likely to lead to multiple time measurements of a corresponding portion of the ground surface, and thus may help in more accurately analyzing the ground surface.

FIGS. 5 and 6 are diagrams for demonstration of estimating for how wide a portion of the ground surface the distance measurement has been performed in an example ground surface analysis process, in other words, how wide a portion of the ground surface is to be analyzed. In FIG. 5, there is shown together with the example projection region 200 of FIG. 2 an example region 500 into which the FoV of the distance sensor 115 is projected on the xy-plane when the distance sensor 115 is located on the z-axis in a three-dimensional coordinate system. In FIG. 6, there is shown together with the example region 200 of FIG. 2 an example region 600 into which the FoV of the distance sensor 115 is projected on the xy-plane when the distance sensor 115 is located on a point l=(lₓ, l_{y}, l_{z}) in the three-dimensional coordinate system.

For the sake of convenience, it is assumed that the region 200 is a region into which the FoV of the distance sensor 115 is projected on a plane that is distant from the distance sensor 115 by a unit distance so that h is, for example, one (1) meter long in FIG. 2. First, it is shown in FIG. 5 that the center point of the region 500, as seen from the origin, has an angle ψ with the x-axis, e.g., the yaw angle of the distance sensor 115, and that the center point of the origin 500, as seen from the distance sensor 115, has an angle θ with the z-axis, e.g., the pitch angle of the distance sensor 115, where each of a pair of two points P₁ and P₂ and a pair of two points P₃ and P₄ on the boundary of the region 200 denotes a pair of two endpoints of a diameter, e.g., the major or minor axis of the ellipse. Then, in this example, coordinates of the four points P₁, P₂, P₃ and P₄ on the boundary of the region 200 may be calculated as follows:

$$\begin{matrix}{P}_{1} = ( cos ψsinθ + sin ψtanβ , sin ψsinθ - cos ψtanβ , h - cos θ ) \\ {P}_{2} = ( cos ψsinθ - sin ψtanβ , sin ψsinθ + cos ψtanβ , h - cos θ ) \\ {P}_{3} = ( \frac{sin ( θ - α ) cos ψ}{cos α} , \frac{sin ( θ - α ) sin ψ}{cos α} , h - \frac{cos ( θ - α )}{cos α} ) \\ {P}_{4} = ( \frac{sin ( θ + α ) cos ψ}{cos α} , \frac{sin ( θ + α ) sin ψ}{cos α} , h - \frac{cos ( θ + α )}{cos α} )\end{matrix} \qquad Eq . 1$$

The four points P₁, P₂, P₃ and P₄ on the boundary of the region 200 may be respectively projected into four corresponding points on a boundary of the region 500. The area of the region 500 may be computed based on coordinates of such corresponding points. For example, the coordinates of each of the corresponding points on the boundary of the region 500 may be calculated using a planar projection shadow equation. According to this equation, letting the location of the distance sensor 115 be the point l=(lₓ, l_{y}, l_{z}) as in FIG. 6, a relationship between any point 620 v=(vₓ, v_{y}, v_{z}) on the region 200 and a point 640 P=(Pₓ, P_{y}, 0) into which the point 620 is projected on the region 600 may be represented as follows:

$${P}_{x} = \frac{{l}_{z} {v}_{x} - {l}_{x} {v}_{z}}{{l}_{z} - {v}_{z}} {P}_{y} = \frac{{l}_{z} {v}_{y} - {l}_{y} {v}_{z}}{{l}_{z} - {v}_{z}} \qquad Eq . 2$$

In some example implementations, the processing unit 150 may estimate, based on an area of each of a plurality of regions into which, in a plurality of respective sensing directions, the FoV of the distance sensor 115 is projected on the reference plane, a possible area of a to-be-finally-analyzed portion of the ground surface, i.e., a union of all of the projection regions. For example, the processing unit 150 may estimate a maximum possible area and/or a minimum possible area of the union of these regions based on an area of each of a plurality of regions, including the regions 310, 320, 330, and 340, into which the FoV of the distance sensor 115 is projected on the plane 300 in a plurality of respective sensing directions, including sensing directions pointing to the points 301, 302, 303, and 304, and possibly based further on the above-described upper limit and lower limit percentages.

In some example implementations, if the estimated area is smaller than a threshold area value, the processing unit 150 may control the distance sensor 115 to be oriented in an additional sensing direction subsequent to the successive orientations in the above-described sensing directions. Accordingly, it is made possible to analyze a ground surface portion with a desired sufficiently wide area while gradually adding sensing directions in which the distance sensor 115 is to be oriented.

In some example implementations, if the estimated area is larger than or equal to the threshold area value, the processing unit 150 may finish collecting the distance measurement data indicative of distances measured by the distance sensor 115 in the respective sensing directions towards the ground surface and may analyze the ground surface based on the collected distance measurement data. Such analysis may include constructing a map of the ground surface as follows.

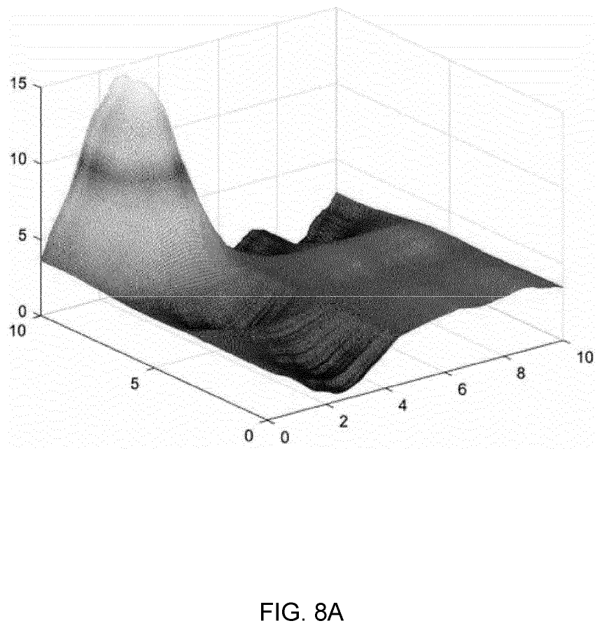

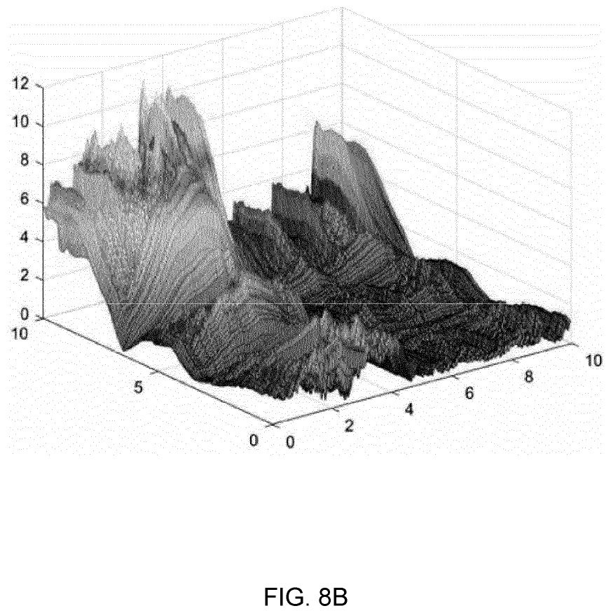

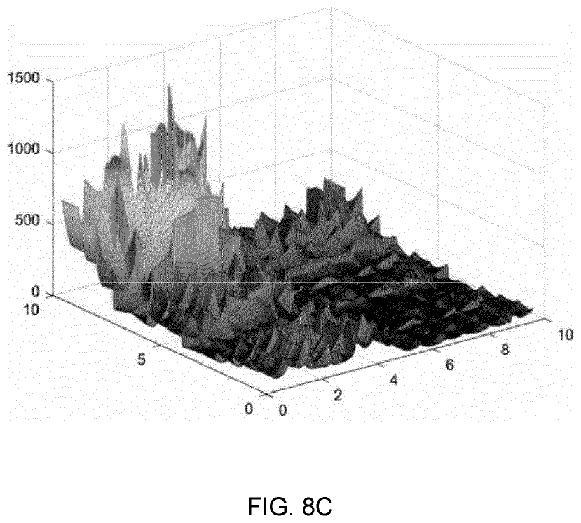

First, the processing unit 150 may receive, from the distance sensor 115, the distance measurement data indicative of the distances measured in the sensing directions towards the ground surface. Therefore, based on the sensing directions of the distance sensor 115, as well as the distance measurement data received from those directions, the processing unit 150 may map, onto a plurality of coordinate points of the ground surface, their respective altitude values indicative of an undulation of the ground surface, for example, an altitude value H_{i,j} calculated for a coordinate point (i,j). As such, the processing unit 150 may construct a topographic map representing such mapping and then select, based on the altitude values, a particular one of the plurality of coordinate points as, e.g., a coordinate point corresponding to a flat place on the ground surface. By way of example, there is shown in FIG. 8A a topographic map in which altitude values are mapped to respective coordinate points given at a spacing of 4 cm in width and 4 cm in length for a ground surface of 10 m width and 10 m length.

Then, by using the topographic map, the processing unit 150 may map, onto the coordinate points represented in the topographic map, their respective slope rate values indicative of a local change rate feature of the undulation of the ground surface. As such, the processing unit 150 may construct a slope rate map representing such mapping and then select, based on the slope rate values, a particular one of the plurality of coordinate points as, e.g., the coordinate point corresponding to the flat place on the ground surface, as described above.

Specifically, for each of the coordinate points, the slope rate value may be calculated based on the altitude value mapped to that coordinate point and the altitude value mapped to each of a first limited number of, e.g., three, nearby coordinate points. For example, as represented by the equation below, the processing unit 150 may calculate an inclination SX_{i,j} between a coordinate point (i,j) and a nearby coordinate point (i+1,j), an inclination SY_{i,j} between the coordinate point (i,j) and a nearby coordinate point (i,j+1), and an inclination SD_{i,j} between the coordinate point (i,j) and a nearby coordinate point (i+1,j+1), and then calculate, for the coordinate point (i,j), the slope rate value SlopeRate_{i,j} to be a norm of the aforementioned three inclination values.

$$S {X}_{i , j} = \frac{( {H}_{i + 1 , j} - {H}_{i , j} )}{{Δ}_{x}} \qquad Eq . 3$$

$$S {Y}_{i , j} = \frac{( {H}_{i , j} - {H}_{i , j + 1} )}{{Δ}_{y}}$$

$$S {D}_{i , j} = \frac{( {H}_{i + 1 , j + 1} - {H}_{i , j} )}{{Δ}_{d}}$$

$${SlopeRate}_{i , j} = \sqrt{S {X}_{i , j}^{2} + S {Y}_{i , j}^{2} + S {D}_{i , j}^{2}}$$

where Δₓ, Δ_{y}, and Δ_{d} are a distance between the coordinate point (i,j) and the coordinate point (i+1,j), a distance between the coordinate point (i,j) and the coordinate point (i,j+1), and a distance between the coordinate point (i,j) and the coordinate point (i+1,j+1), respectively. By way of example, there is shown in FIG. 8B an example slope rate map which is constructed from the topographic map of FIG. 8A in the above-described manner.

By using the topographic map instead of, or in addition to, the mapping of the slope rate values, the processing unit 150 may map, onto the coordinate points represented in the topographic map, their respective roughness values indicative of another local change rate feature of the undulation of the ground surface. As such, the processing unit 150 may construct a roughness map representing such mapping and then select, based on the roughness values, a particular one of the plurality of coordinate points as, e.g., the coordinate point corresponding to the flat place on the ground surface, as described above.

Specifically, for each of the coordinate points, the roughness value may be calculated based on the altitude value mapped to that coordinate point and the altitude value mapped to each of a second limited number, e.g., greater than the above-mentioned first number, of nearby coordinate points. For example, for a sample region defined with several, e.g., a number N×N of, adjacent coordinate points of the ground surface, the processing unit 150 may calculate a difference between the altitude value mapped to a coordinate point (i,j) in the sample region and the altitude value mapped to each of all other coordinate points (m,n) in the sample region, calculate a distance d_{m,n,i,j} between those two coordinate points, and then calculate the roughness value Roughness_{i,j} for the coordinate point (i,j), as follows:

Roughness_{i,j}=Σₘ₌₁^{N}Σₙ₌₁^{N}\sqrt{(H_{m,n}−H_{i,j})²}/d_{m,n,i,j} Eq. 4

As such, this equation contemplates that as the distance dd_{m,n,i,j} becomes greater, the altitude difference will have a less effect on the local surface roughness at the coordinate point (i,j). By way of example, there is shown in FIG. 8C an example roughness map which is constructed from the topographic map of FIG. 8A in the above-described manner when for this topographic map, several non-overlapping sample regions are defined, each of which is sized to have a width of 84 cm and a length of 84 cm.

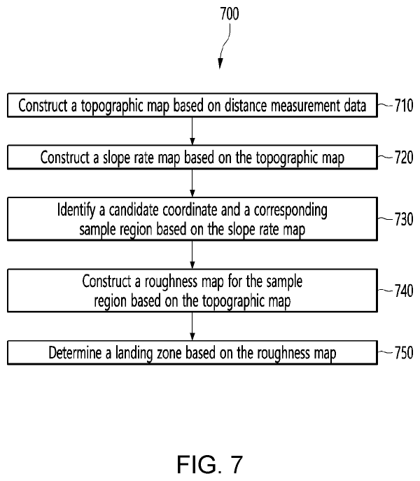

As mentioned earlier, each of the slope rate and the roughness values defined for a coordinate point is indicative of a local change rate feature of the undulation of the ground surface. Further, it means that as these two values becomes smaller, that coordinate point is highly likely to correspond to a flatter place of the ground surface. In addition, the slope rate may be obtained in a relatively simpler and less time-consuming fashion, and the roughness may indicate a degree of flatness of the ground surface in a relatively more accurate manner. In a particular example, the processing unit 150 may determine a flat place of the ground surface in an efficient manner using a proper combination of the scheme of calculation of slope rate values and the scheme of calculation of roughness values, as described below with respect to FIG. 7.

In the following, with reference to FIG. 7, there is described in detail an example of a process 700 of selecting a landing zone for the UAV 10. In order to select a landing zone in an unknown environment as mentioned earlier, the UAV 10 may perform the process 700 of FIG. 7. For example, the process 700 may be performed by the navigation and control system 100 of the UAV 10, and in particular by the processing unit 150. Other example flows of the process 700 are also contemplated. For example, the process 700 may further include an additional operation that is not shown and/or may include some of, but not all of, the operations shown in FIG. 7.

In an operation 710, a topographic map is constructed based on distance measurement data collected from the distance sensor 115 of the UAV 10. As mentioned earlier, the distance measurement data may be indicative of distances respectively measured by the distance sensor 115 in a plurality of sensing directions towards a ground surface. Accordingly, altitude values at a plurality of respective coordinate points of the ground surface may be calculated and the calculated altitude values may be included in the topographic map.

In an operation 720, a slope rate map is constructed based on the constructed topographic map. As mentioned earlier, a slope rate value at each of the coordinate points may be calculated based on the altitude value at that coordinate point and the altitude value at each of a limited number of coordinate points lying near that coordinate point, e.g., in accordance with Eq. 3, and the calculated slope rate value may be included in the slope rate map.

In an operation 730, a candidate coordinate point of the plurality of coordinate points of the ground surface and a corresponding sample region of the ground surface are identified based on the constructed slope rate map, where the candidate coordinate point and another limited number of coordinate points lying near the candidate coordinate point are all coordinate points in this sample region. For example, one of the plurality of coordinate points that satisfies a certain decision criterion, e.g., a coordinate point that has a slope rate value less than a threshold slope rate value, in other words, a coordinate point that has a slope rate value whose reciprocal is greater than a threshold value, may be identified as the candidate coordinate point. Subsequently, the sample region may be identified with the identified candidate coordinate point centered therein, which sample region may be regarded as a group of a number of, e.g., N×N, coordinate points.

In an operation 740, a roughness map is constructed based on the topographic map for the identified sample region. For example, a roughness value at each of the coordinate points in the sample region may be calculated based on the altitude value at that coordinate point and the altitude value at each of the other coordinate points in the sample region, e.g., in accordance with Eq. 4, and the calculated roughness value may be included in the roughness map.

As long as there exists another coordinate point that satisfies the aforementioned decision criterion, the operations 730 and 740 may be repeated. However, even with a candidate coordinate point identified, if its corresponding sample region is not defined only with coordinate points represented in the topographic map in a manner identical to that for another sample region, the candidate coordinate point may be discarded and the roughness map of the sample region may also not be constructed.

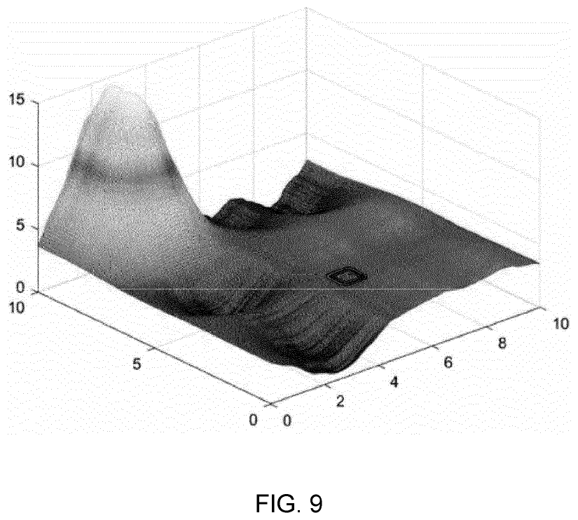

In an operation 750, a landing zone of the UAV 10 is determined based on the constructed roughness map. For example, for each identified sample region, an average of the roughness values mapped to their respective coordinate points in that region may be computed. Then, the landing zone of the UAV 10 may be selected to correspond to a sample region having a minimum average value, e.g., the region surrounded by a thick border in the topographic map shown in FIG. 9.

As such, in accordance with the example process 700, it is possible to: select a number of coordinate points that are more than likely to correspond to a landing zone of the UAV 10 by using slope rate values that may be calculated in a simple manner (i.e., rapid but rough analysis of the ground surface); perform an evaluation of a sample region taken with each selected coordinate point centered therein by using roughness values that are required to be calculated in a relatively complex manner (i.e., more precise analysis of the selected region of the ground surface); and thereby finally determine the landing zone of the UAV 10. In this way, it is possible to efficiently select an optimal flat region on which the UAV 10 may safely land even in any environment, e.g., an unknown environment.

The following are various examples pertaining to aerial analysis of a ground surface using a distance sensor of a UAV.

In Example 1, a method for aerial analysis of a ground surface includes: controlling a distance sensor of an unmanned aerial vehicle (UAV) to be successively oriented in a plurality of sensing directions towards the ground surface; and analyzing the ground surface based on distance measurement data indicative of distances respectively measured by the distance sensor in the plurality of sensing directions.

Example 2 includes the subject matter of Example 1, wherein the method is performed during hovering of the UAV above the ground surface.

Example 3 includes the subject matter of Example 1 or 2, wherein the plurality of sensing directions includes one or more slantingly downward directions.

Example 4 includes the subject matter of Example 3, wherein the plurality of sensing directions further includes one vertically downward direction.

Example 5 includes the subject matter of any of Examples 1 to 4, wherein the plurality of sensing directions corresponds to their respective points defining a planar trajectory, wherein the planar trajectory includes a plurality of loops winding an identical inner point.

Example 6 includes the subject matter of Example 5, wherein controlling the distance sensor includes controlling the distance sensor such that a heading direction of the distance sensor follows the planar trajectory across the successive orientations.

Example 7 includes the subject matter of Example 5 or 6, wherein the plurality of loops is a plurality of open-ended loops, is a plurality of closed loops, or is one or more open-ended loops and one or more closed loops.

Example 8 includes the subject matter of any of Examples 5 to 7, wherein the planar trajectory is a spiral trajectory.

Example 9 includes the subject matter of any of Examples 1 to 8, wherein controlling the distance sensor includes determining a subsequent one of the plurality of sensing directions based on a region into which, in a current one of the plurality of sensing directions, a field of view (FoV) of the distance sensor is projected on a reference plane.

Example 10 includes the subject matter of Example 9, wherein the determination is made such that the region overlaps another region into which, in the subsequent direction, the FoV is projected on the reference plane and/or such that the other region has a larger area than that of the region.

Example 11 includes the subject matter of Example 9 or 10, wherein the method further includes controlling the distance sensor to be oriented in an additional sensing direction subsequent to the successive orientations if a possible area of a union of a plurality of regions into which, in respective ones of the plurality of sensing directions, the FoV is projected on the reference plane is less than a threshold value, wherein the ground surface is analyzed based further on additional distance measurement data received from the distance sensor in the additional sensing direction.

Example 12 includes the subject matter of any of Examples 9 to 11, wherein the FoV is defined by a limited horizontal angle of view and a limited vertical angle of view.

Example 13 includes the subject matter of any of Examples 1 to 12, wherein the UAV is a rotorcraft drone.

Example 14 includes the subject matter of any of Examples 1 to 13, wherein the UAV is a vertical take-off and landing (VTOL) UAV.

Example 15 includes the subject matter of any of Examples 1 to 14, wherein analyzing the ground surface includes: calculating, based on the distance measurement data, altitude values at a plurality of respective coordinate points of the ground surface; and selecting, based on the altitude values, a particular one of the plurality of coordinate points.

Example 16 includes the subject matter of Example 15, wherein selecting the particular coordinate point includes: calculating, based on the altitude values, slope rate values at the respective coordinate points; and selecting, based on the slope rate values, the particular coordinate point.

Example 17 includes the subject matter of Example 16, wherein selecting, based on the slope rate values, the particular coordinate point includes: identifying, based on the slope rate values, a candidate coordinate point of the plurality of coordinate points and a corresponding sample region of the ground surface, the candidate coordinate point and another limited number of nearby ones of the plurality of coordinate points being all coordinate points in the corresponding sample region; calculating, based on the altitude values at respective ones of all of the coordinate points in the corresponding sample region, roughness values at the respective coordinate points in the corresponding sample region; and selecting, based on the roughness values, the particular coordinate point.

Example 18 includes the subject matter of any of Examples 15 to 17, wherein the particular coordinate point is selected as a coordinate point corresponding to a landing zone of the UAV.

In Example 19, there is provided a computer-readable storage medium having stored therein computer-executable instructions that when executed by a computer processor, cause the computer processor to perform the method recited in any of Examples 1 to 18.

In Example 20, a computing apparatus includes: a processor; and a memory encoded with a set of computer program instructions executable by the processor to perform the method recited in any of Examples 1 to 18.

In Example 21, an unmanned aerial vehicle (UAV) includes: a distance sensor; an actuator; and a processing unit to perform operations for aerial analysis of a ground surface, the operations including: causing the actuator to successively orient the distance sensor in a plurality of sensing directions towards the ground surface; and analyzing the ground surface based on distance measurement data indicative of distances respectively measured by the distance sensor in the plurality of sensing directions.

Example 22 includes the subject matter of Example 21, wherein the operations are performed during hovering of the UAV above the ground surface.

Example 23 includes the subject matter of Example 21 or 22, wherein the plurality of sensing directions includes one or more slantingly downward directions.

Example 24 includes the subject matter of Example 23, wherein the plurality of sensing directions further includes one vertically downward direction.

Example 25 includes the subject matter of any of Examples 21 to 24, wherein the plurality of sensing directions corresponds to their respective points defining a planar trajectory, wherein the planar trajectory includes a plurality of loops winding an identical inner point.

Example 26 includes the subject matter of Example 25, wherein causing the actuator to successively orient the distance sensor in the plurality of sensing directions includes causing the actuator to orient the distance sensor such that a heading direction of the distance sensor follows the planar trajectory across the successive orientations.

Example 27 includes the subject matter of Example 25 or 26, wherein the plurality of loops is a plurality of open-ended loops, is a plurality of closed loops, or is one or more open-ended loops and one or more closed loops.

Example 28 includes the subject matter of any of Examples 25 to 27, wherein the planar trajectory is a spiral trajectory.

Example 29 includes the subject matter of any of Examples 21 to 28, wherein causing the actuator to successively orient the distance sensor in the plurality of sensing directions includes determining a subsequent one of the plurality of sensing directions based on a region into which, in a current one of the plurality of sensing directions, a field of view (FoV) of the distance sensor is projected on a reference plane.

Example 30 includes the subject matter of Example 29, wherein the determination is made such that the region overlaps another region into which, in the subsequent direction, the FoV is projected on the reference plane and/or such that the other region has a larger area than that of the region.

Example 31 includes the subject matter of Example 29 or 30, wherein the processing unit is further to cause the actuator to orient the distance sensor in an additional sensing direction subsequent to the successive orientations if a possible area of a union of a plurality of regions into which, in respective ones of the plurality of sensing directions, the FoV is projected on the reference plane is less than a threshold value, wherein the ground surface is analyzed based further on additional distance measurement data received form the distance sensor in the additional sensing direction.

Example 32 includes the subject matter of any of Examples 29 to 31, wherein the FoV is defined by a limited horizontal angle of view and a limited vertical angle of view.

Example 33 includes the subject matter of any of Examples 21 to 32, wherein the UAV is a rotorcraft drone.

Example 34 includes the subject matter of any of Examples 21 to 33, wherein the UAV is a vertical take-off and landing (VTOL) UAV.

Example 35 includes the subject matter of any of Examples 21 to 35, wherein analyzing the ground surface includes: calculating, based on the distance measurement data, altitude values at a plurality of respective coordinate points of the ground surface; and selecting, based on the altitude values, a particular one of the plurality of coordinate points.

Example 36 includes the subject matter of Example 35, wherein selecting the particular coordinate point includes: calculating, based on the altitude values, slope rate values at the respective coordinate points; and selecting, based on the slope rate values, the particular coordinate point.

Example 37 includes the subject matter of Example 36, wherein selecting, based on the slope rate values, the particular coordinate point includes: identifying, based on the slope rate values, a candidate coordinate point of the plurality of coordinate points and a corresponding sample region of the ground surface, the candidate coordinate point and a limited number of nearby ones of the plurality of coordinate points being all coordinate points in the corresponding sample region; calculating, based on the altitude values at respective ones of all of the coordinate points in the corresponding sample region, roughness values at the respective coordinate points in the corresponding sample region; and selecting, based on the roughness values, the particular coordinate point.

Example 38 includes the subject matter of any of Examples 35 to 37, wherein the particular coordinate point is selected as a coordinate point corresponding to a landing zone of the UAV.

In a particular example, the apparatus, device, system, machine, or the like discussed herein may be, include, or be implemented in any suitable type of computing apparatus. The computing apparatus may include a processor and a computer readable storage medium that is readable by the processor. The processor may execute one or more instructions stored in the computer readable storage medium. The processor may also read other information stored in the computer readable storage medium. In addition, the processor may store new information in the computer readable storage medium and update certain information stored in the computer readable storage medium. The processor may include, for example, a central processing unit (CPU), a digital signal processor (DSP), a graphics processing unit (GPU), a processor core, a microprocessor, a micro-controller, a field-programmable gate array (FPGA), an application specific integrated circuit (ASIC), other hardware and logic circuits, or any suitable combination thereof. The computer readable storage medium is encoded with a variety of information, for example, a set of processor executable instructions that are executable by the processor, and/or other information. For example, the computer-readable storage medium may have stored therein computer program instructions that when executed by the processor, cause the computing apparatus, e.g., the processor, to perform some operations disclosed herein and/or information, data, variables, constants, data structures, and the like that are used in such operations. The computer-readable storage medium may include read-only memory (ROM), random-access memory (RAM), volatile memory, non-volatile memory, removable memory, non-removable memory, flash memory, solid-state memory, other types of memory devices, magnetic media such as a hard disk, a floppy disk, and a magnetic tape, optical recording media such as a CD-ROM and a DVD, magneto-optical media such as a floptical disk, other types of storage devices and storage media, or any suitable combination thereof.

In a particular example, the operations, techniques, processes, or certain aspects or portions thereof, described herein may be embodied in a computer program product. Such computer program may be implemented in a certain type of, e.g., compiled or interpreted, programming language that is executable by a computer, such as assembly, machine language, procedural language, object-oriented language, and the like, and may be combined with hardware implementation. The computer program product may be distributed in the form of a computer-readable storage medium or in an on-line manner. For the online distribution, a portion or whole of the computer program product may be temporarily stored, or temporarily created, in a server, for example, in a computer-readable storage medium of the server.

The foregoing description has been presented to illustrate and describe some examples in detail. It should be understood by those skilled in the art that many modifications and variations are possible in light of the above teaching. In various examples, suitable results may be achieved if the above-described techniques are performed in a different order, and/or if some of the components of the above-described systems, architectures, devices, circuits, and the like are coupled or combined in a different manner, or substituted for or replaced by other components or equivalents thereof.

Therefore, the scope of the disclosure is not to be limited to the precise form disclosed, but rather defined by the following claims and equivalents thereof.

1. A method for aerial analysis of a ground surface, comprising:
controlling a distance sensor of an unmanned aerial vehicle (UAV) to be successively oriented in a plurality of sensing directions towards the ground surface; and
analyzing the ground surface based on distance measurement data indicative of distances respectively measured by the distance sensor in the plurality of sensing directions, the plurality of sensing directions corresponding to respective points defining a planar trajectory, the planar trajectory comprising a plurality of loops winding an identical inner point.

2. The method of claim 1, wherein the planar trajectory is a spiral trajectory.

3. The method of claim 1, wherein controlling the distance sensor comprises controlling the distance sensor such that a heading direction of the distance sensor follows the planar trajectory across the successive orientations.

4. The method of claim 1, wherein controlling the distance sensor comprises determining a subsequent one of the plurality of sensing directions such that a region into which, in a current one of the plurality of sensing directions, a field of view (FoV) of the distance sensor is projected on a reference plane overlaps another region into which, in the subsequent direction, the FoV is projected on the reference plane and/or such that said another region has a larger area than that of the region.

5. The method of claim 4, further comprising: controlling the distance sensor to be oriented in an additional sensing direction subsequent to the successive orientations if a possible area of a union of a plurality of regions into which, in respective ones of the plurality of sensing directions, the FoV is projected on the reference plane is less than a threshold area value, wherein the ground surface is analyzed based further on additional distance measurement received form the distance sensor in the additional sensing direction.

6. The method of claim 1, wherein analyzing the ground surface comprises: calculating, based on the distance measurement data, altitude values at a plurality of respective coordinate points of the ground surface; calculating, based on the altitude values, slope rate values at the respective coordinate points; and selecting, based on the slope rate values, a particular one of the plurality of coordinate points.

7. The method of claim 6, wherein selecting, based on the slope rate values, the particular coordinate point comprises: identifying, based on the slope rate values, a candidate coordinate point of the plurality of coordinate points and a corresponding sample region of the ground surface, the candidate coordinate point and a limited number of nearby ones of the plurality of coordinate points being all coordinate points in the corresponding sample region; calculating, based on the altitude values at respective ones of said all coordinate points in the corresponding sample region, roughness values at the respective coordinate points in the corresponding sample region; and selecting, based on the roughness values, the particular coordinate point.

8. A computing apparatus, comprising:
a processor; and
a memory encoded with a set of computer program instructions executable by the processor for aerial analysis of a ground surface, the set comprising:
instructions to control a distance sensor of an unmanned aerial vehicle (UAV) to be successively oriented in a plurality of sensing directions towards the ground surface; and
instructions to analyze the ground surface based on distance measurement data indicative of distances respectively measured by the distance sensor in the plurality of sensing directions, the plurality of sensing directions corresponding to respective points defining a planar trajectory, the planar trajectory comprising a plurality of loops winding an identical inner point.

9. The computing apparatus of claim 8, wherein the planar trajectory is a spiral trajectory.

10. The computing apparatus of claim 8, wherein the instructions to control the distance sensor comprise instructions to control the distance sensor such that a heading direction of the distance sensor follows the planar trajectory across the successive orientations.

11. The computing apparatus of claim 8, wherein the instructions to control the distance sensor comprise instructions to determine a subsequent one of the plurality of sensing directions such that a region into which, in a current one of the plurality of sensing directions, a field of view (FoV) of the distance sensor is projected on a reference plane overlaps another region into which, in the subsequent direction, the FoV is projected on the reference plane and/or such said another region has a larger area than that of the region.

12. The computing apparatus of claim 11, wherein the set further comprises instructions to control the distance sensor to be oriented in an additional sensing direction subsequent to the successive orientations if a possible area of a union of a plurality of regions into which, in respective ones of the plurality of sensing directions, the FoV is projected on the reference plane is less than a threshold area value, wherein the ground surface is analyzed based further on additional distance measurement received form the distance sensor in the additional sensing direction.

13. The computing apparatus of claim 8, wherein the instructions to analyze the ground surface comprise: instructions to calculate, based on the distance measurement data, altitude values at a plurality of respective coordinate points of the ground surface; instructions to calculate, based on the altitude values, slope rate values at the respective coordinate points; and instruction to select, based on the slope rate values, a particular one of the plurality of coordinate points.

14. The computing apparatus of claim 13, wherein the instructions to select, based on the slope rate values, the particular coordinate point comprise: instructions to identify, based on the slope rate values, a candidate coordinate point of the plurality of coordinate points and a corresponding sample region of the ground surface, the candidate coordinate point and a limited number of nearby ones of the plurality of coordinate points being all coordinate points in the corresponding sample region; instructions to calculate, based on the altitude values at respective ones of said all coordinate points in the corresponding sample region, roughness values at the respective coordinate points in the corresponding sample area; and instructions to select, based on the roughness values, the particular coordinate point.

15. An unmanned aerial vehicle (UAV), comprising:
a distance sensor;
an actuator; and
a processing unit to perform operations for aerial analysis of a ground surface, the operations comprising: causing the actuator to successively orient the distance sensor in a plurality of sensing directions towards the ground surface; and analyzing the ground surface based on distance measurement data indicative of distances respectively measured by the distance sensor in the plurality of sensing directions, the plurality of sensing directions corresponding to respective points defining a planar trajectory, the planar trajectory comprising a plurality of loops winding an identical inner point.

16. The UAV of claim 15, wherein the planar trajectory is a spiral trajectory.

17. The UAV of claim 15, wherein causing the actuator to successively orient the distance sensor in the plurality of sensing directions comprises determining a subsequent one of the plurality of sensing directions such that a region into which, in a current one of the plurality of sensing directions, a field of view (FoV) of the distance sensor is projected on a reference plane overlaps another region into which, in the subsequent direction, the FoV is projected on the reference plane and/or such that said another region has a larger area than that of the region.

18. The UAV of claim 17, wherein the processing unit is further to cause the actuator to orient the distance sensor in an additional sensing direction subsequent to the successive orientations if a possible area value of a union of a plurality of regions into which, in respective ones of the plurality of sensing directions, the FoV is projected on the reference plane is less than a threshold area value, wherein the ground surface is analyzed based further on additional distance measurement received form the distance sensor in the additional sensing direction.

19. The UAV of claim 15, wherein analyzing the ground surface comprises: calculating, based on the distance measurement data, altitude values at a plurality of respective coordinate points of the ground surface; calculating, based on the altitude values, slope rate values at the respective coordinate points; and selecting, based on the slope rate values, a particular one of the plurality of coordinate points.

20. The UAV of claim 19, wherein selecting, based on the slope rate values, the particular coordinate point comprises: identifying, based on the slope rate values, a candidate coordinate point of the plurality of coordinate points and a corresponding sample region of the ground surface, the candidate coordinate point and a limited number of nearby ones of the plurality of coordinate points being all coordinate points in the corresponding sample region; calculating, based on the altitude values at respective ones of said all coordinate points in the corresponding sample region, roughness values at the respective coordinate points in the corresponding sample region; and selecting, based on the roughness values, the particular coordinate point.
